(19) United States
(12) Patent Application Publication
(10) Pub. No.: US 2015/0344239 A1
(43) Pub. Date: Dec. 3, 2015

(54) Apparatus For Transporting Cylindrical Containers

(71) Applicant: Schuler Pressen GmbH, Goppingen (DE)

(72) Inventor: Klaus Blei, Wangen (DE)

(73) Assignee: Schuler Pressen GmbH, Goppingen (DE)

(21) Appl. No.: 14/366,134

(22) PCT Filed: Nov. 14, 2012
(86) PCT No.: PCT/EP2012/072614

§ 371 Date: Jun. 17, 2014

(30) Foreign Application Priority Data
Dec. 19, 2011 (DE) 10 2011 056 609.0

(51) Int. Cl. B65G 47/84

(52) U.S. Cl. CPC B65G 47/846

(57) ABSTRACT

The apparatus transports cylindrical containers between different operating stations. The containers are thereby transported successively between adjacent operating stations in a stepwise manner. The apparatus encompasses a main drive, which is equipped to move receiving units of the apparatus along a predetermined path between two operating stations. Each receiving unit encompasses a holding device for holding an assigned container. The holding device of the receiving unit encompasses a cylindrical clamping mandrel comprising a plurality of clamping segments.

### BACKGROUND OF THE INVENTION

The invention relates to an apparatus for transporting or positioning, respectively, cylindrical containers. Such containers are can bodies, which are produced by means of impact extrusion or deep drawing, for example. The containers, which are to be transported and/or positioned, encompass a cylindrical jacket surface, one end of which is closed by means of a can base or by means of a different can part, for example, and the other axial end of which is open. In the area of the open end, the container can encompass a portion, in which it tapers.

Such containers are transported between a plurality of operating stations and are accurately positioned in the respective operating station by means of the apparatus according to the invention. Different processing operations can be carried out in each operating station. For example, one or a plurality of operating stations serve to receive or deliver, respectively, the containers into or out of the transporting apparatus, respectively. In other operating stations, the containers are tested, recorded, cut or imprinted, for example. The apparatus transports a container successively along a predetermined path in a stepwise manner from one operating station to the next in a predetermined order.

Such a transporting apparatus is described in DE 10 2009 058 222 A1, for example. A system for imprinting containers is also disclosed therein. In the case of the system described therein, containers are arranged in individual holders in a rotatable manner. In this position, the containers are transported individually and are transported successively to the printing machine and are imprinted. Each holder encompasses a marking for being able to adjust the angle of rotation about the axis of rotation to a sufficiently accurate extent in response to the imprinting of the container. The rotation of the container or of the holder, respectively, takes place via a belt drive, wherein the accuracy of the adjustment of the rotational position can encompass undesirably high tolerances due to large masses, which are to be accelerated, and due to temperature fluctuations. In addition, such an apparatus is subject to a high wear, whereby the printing quality is negatively impacted. According to DE 10 2009 058 222 A1, these disadvantages are overcome in that each clamping device for a container is assigned its own servomotor or its own step motor for rotating the container.

### SUMMARY OF THE INVENTION

Based on this known state of the art, it can be considered to be an object of the instant invention to create a transporting apparatus, which provides for a high flow capacity accompanied by a high level of accuracy.

This object is solved by means of a transporting apparatus comprising the features of patent claim 1.

The apparatus according to the invention serves for transporting cylindrical containers between different operating stations. The containers are thereby transported successively between adjacent operating stations in a stepwise manner, so to speak. A testing and/or a processing of the container can take place in each operating station. For example, the container can be imprinted in one or a plurality of operating stations. In particular, it is advantageous thereby, if only one printing ink is applied to the container in an operating station. For imprinting, provision can be made for 4 to 5 operating stations, for example. Following the imprinting, the container can be dried and/or provided with a protective lacquer in one or a plurality of subsequent operating stations.

The apparatus encompasses a main drive, which is equipped to move receiving units of the apparatus along a predetermined path between two operating stations. Each receiving unit encompasses a holding device for holding an assigned container. Each receiving unit furthermore encompasses a guide body arrangement comprising one or a plurality of guide bodies. The guide bodies can be formed by means of one guide roller in each case, for example. The guide bodies are supported on a guide surface of a guide device, which extends along or parallel to the path, on which the receiving units are moved between the operating stations. Preferably, the guide surface has a ring-shaped and in particular a circular ring-shaped course, so that the receiving units are moved on a circular path in response to the operation of the main drive.

The receiving units are free from their own drives. Moved weight and in particular weight, which is to be accelerated, can be reduced through this, whereby the transport time is very short and the flow rate is thus very large in response to the processing or testing, respectively, of containers. At least one of the operating stations and, according to the example, a plurality of operating stations are embodied as rotary operating stations, in which the container is rotated about an axis of rotation, which preferably coincides with the longitudinal axis of the container, during the testing and/or processing. To initiate this rotation, the guide device encompasses a guide segment, which can be driven about the axis of rotation and which is assigned to the rotary operating station. This guide segment includes a portion of the guide surface. If the receiving unit is in the rotary operating station, the at least one guide body of the guide body arrangement rests against the surface portion of the rotatable guide segment. When the guide segment is rotated, the guide body arrangement is thus also moved about the axis of rotation and can effect a rotation of the container, which is held by the holding device of the receiving unit, in this manner. A motor, which is entrained with the receiving unit, is not necessary in the case of this arrangement. It is thus also no longer necessary to supply energy to the receiving units, which can be moved along the path, which is always extensive and problematic in the case of moved units. The design of the transporting apparatus is thus simplified significantly through this. Consequently, the receiving units neither encompass electrical, nor pneumatic, nor hydraulic connections or supply lines.

Advantageously, the guide device encompasses a disk or ring-shaped guide body, on which a plurality of first surface portions of the guide surface are arranged. At the at least one rotary operating station, the guide body can thereby encompass an aperture, in which the guide segment, which is assigned to the rotary operating station, is arranged. During the movement of a receiving unit into or out of the rotary operating station, the guide segment thereby assumes an initial position, in which the second surface portion of the guide surface, which is arranged on the guide segment, connects the two first surface portions of the guide surface, which are present adjacent to the aperture, to one another. The connection between a first surface portion and a second surface portion is in particular continuous.

In the case of a preferred embodiment, the curvature of the second surface portion is identical with the curvature of the two adjacent first surface portions of the guide surface. The guide bodies of the guide body arrangement, which are moved along the guide surface, can thereby be moved along the guide surface by means of constant contact pressure.

Preferably, each rotary operating station encompasses a rotary drive for rotating the assigned guide segment. The rotary drive is thereby arranged in a stationary manner on a frame of the apparatus and does not contribute to increasing the masses, which are to be accelerated.

In the case of an exemplary embodiment, the main drive encompasses an intermittingly driven main shaft. A support device can be connected in a torque-proof manner to said main shaft. Preferably, the support device encompasses a plurality of apertures, in which a receiving unit is in each case arranged so as to be rotatable about a receiving axis relative to the support device. If a receiving unit is in a rotary operating station, the receiving axis coincides with the axis of rotation of the guide segment. In response to a rotation of the guide segment about the axis of rotation, the guide body arrangement also moves about this axis of rotation and initiates a rotation of the receiving unit about the receiving axis.

In the case of a preferred exemplary embodiment, the at least one guide body of the guide body arrangement is arranged so as to be offset relative to the receiving axis. A predetermined rotary position of the receiving unit can be predetermined via the guide surface and the at least one guide body. If a guide segment is rotated in a rotary operating station, the at least one guide body is thereby moved on a circular path about the axis of rotation or about the receiving axis, respectively, which coincides with the axis of rotation.

It is furthermore advantageous, if the holding device of the receiving unit encompasses a cylindrical clamping mandrel comprising a plurality of clamping segments. The clamping segments are pressed radially away from the longitudinal axis of the clamping mandrel by means of the force of a clamping means in outward direction. In the case of a preferred embodiment, the clamping means is designed as passive clamping means, which creates a clamping force without supply of energy.

The clamping means can furthermore act on a clamping ram, which can be moved in the direction of the longitudinal axis of the clamping mandrel, in a clamping direction. The force of the clamping means exerted on the clamping ram can be converted into a radial clamping force of the clamping segments via a wedge drive. It is thereby possible for the clamping ram to encompass a clamping part comprising a clamping surface, which tapers conically in clamping direction. Adapted accordingly, the clamping segments can in each case encompass a conical contact surface, which preferably rests against the clamping surface across its entire length. The clamping ram can be moved in clamping direction by the force of the clamping means and can press the clamping segments of the clamping mandrel radially outwards due to the tapering of the clamping surface and of the contact surface. If the clamping mandrel is located in the interior of a container, the clamping segments are thereby pressed against the inner surface of the container and thus secure the container to the receiving unit.

It is furthermore advantageous, if the holding device encompasses an operating part, which can be moved against the force of the clamping means for releasing the clamping force or holding force between the clamping mandrel and the container, which is held thereon, and which can in particular be moved linearly. The operating part can be pressed against the clamping ram, for example opposite the clamping direction, or can also be fixedly connected to the clamping ram. Preferably, the receiving unit itself does not encompass an actuator for operating the operating part. Instead, it is advantageous, if at least one operating station of the apparatus is designed as transfer operating station, which encompasses an actuator for operating the operating part. Such an actuator can encompass a linear drive, for example. In the case of this embodiment, the actuator can be arranged on the frame of the apparatus in a stationary manner.

Advantageous embodiments of the invention follow from the dependent patent claims as well as from the description. The description is limited to significant features of the invention. The drawing is to be used in a supplemental manner. The exemplary embodiments of the invention will be specified in more detail below with reference to the drawing.

### IN THE DRAWINGS

FIG. 1 shows a highly schematized block diagram-like illustration of different operating stations of an exemplary embodiment of a transporting apparatus,

FIG. 2 shows an exemplary embodiment of a transporting apparatus in a schematic illustration in vertical cross section,

FIG. 3 is a block diagram of a part of the operating stations according to FIG. 1 comprising a plurality of rotary operating stations,

FIG. 4 is a rotatable guide segment of a rotary operating station with view onto the second portion of the guide surface, which is present at the guide segment,

FIG. 5 is a block diagram-like illustration of an operating station of the transporting apparatus according to FIG. 2, which is embodied as transfer operating station,

FIG. 6 is a schematic, cut illustration of a receiving unit comprising holding device in a transfer operating station according to FIG. 5,

FIG. 7 is the schematic, cut illustration of the holding device according to FIG. 6 in a rotary operating station and

FIG. 8 is an alternative embodiment of a holding device of a receiving unit.

### DETAILED DESCRIPTION OF THE INVENTION

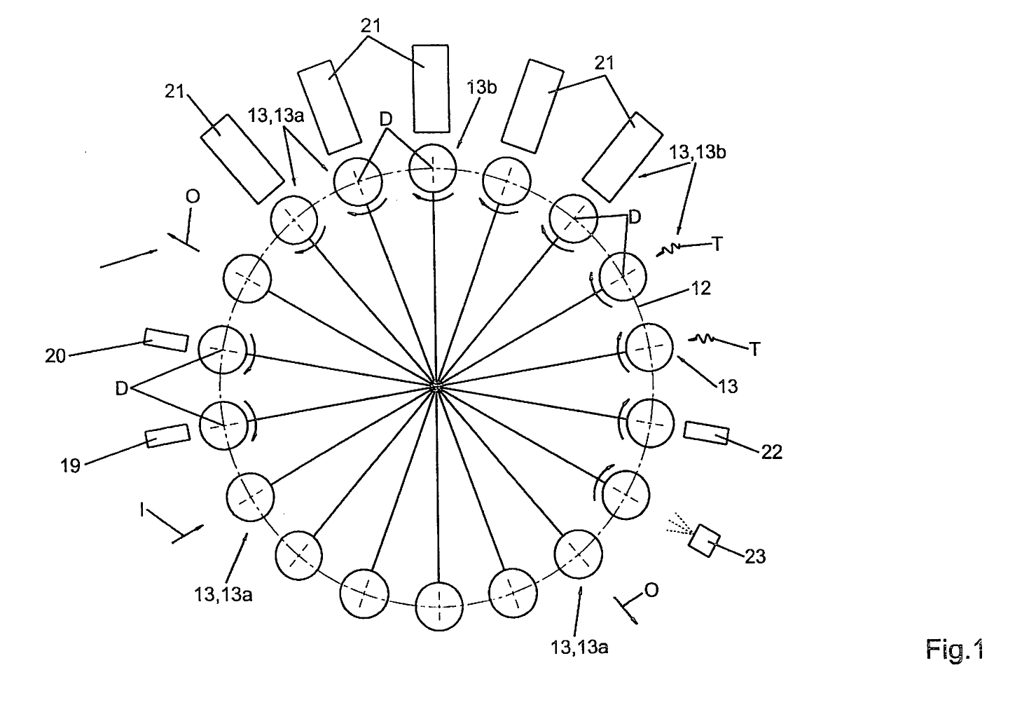

The invention relates to an apparatus 10 for transporting cylindrical containers 11 along a path 12 between a plurality of operating stations 13 of the apparatus 10. In the case of the exemplary embodiment, the path 12 is formed by means of a circular path. The operating stations 13 are arranged so as to be distributed evenly along this circular path 12. In the case of the exemplary embodiment illustrated in FIG. 1, 18 operating stations are present. The apparatus 10 furthermore serves to move and/or position the containers 11 in the individual operating stations 13.

The containers 11 encompass a cylindrical jacket surface 14 as well as a container base 15 or a different container part, which closes the container 11 at an axial end. The container 11 is open at the axial end opposite the container base 15. For example, the container 11 can be a can body, which serves to produce an aerosol can or a beverage can. The container 11 is preferably made of metal, for example of aluminum.

The container 11 is tested and/or processed in the individual operating stations 13. In the case of the exemplary embodiment described herein, provision is made for a plurality of operating stations 13, so as to imprint the outside of the jacket surface 14 of the container 11. Other operating stations serve to prepare the imprinting or the post-processing, respectively. The processing sequence in the individual operating stations 13 is illustrated schematically in FIG. 1. A first operating station is embodied as transfer operating station 13a, in which a container 11, which has not yet been imprinted, is taken over by the apparatus 10. The first operating station is identified by means of an arrow I, which symbolizes the take-over of a new container 11. The container 11 is then transported successively in clockwise direction through a number of operation stations 13. A second operating station 13 encompasses a recording unit 19, which captures the container 11. Via this capturing, a motif, which is assigned to this container 11, can be assigned to the container 11.

A test unit 20, which tests the condition of the container 11, is present in the subsequent third operating station 13. If the container 11 is damaged or encompasses other features outside of the tolerance, it is removed from the apparatus 10 in the next, fourth operating station, which is identified by means of the arrow 0. In the subsequent four or five operating stations, the container 11 is imprinted with a desired motif. A printing unit 21 is thereby assigned to each of these operating stations. In the case of the exemplary embodiment, each printing unit 21 serves to imprint a color on the container. Following the operating stations 13, which serve to imprint, provision is made for at least one and, according to the example, for two operating stations 13 for drying the imprint. For example, the drying can take place by heating the container. The drying stations are identified by means of the wavy line-shaped arrow T. The heating of the containers 11 for drying can also take place inductively.

Following the operating stations 13 for drying the containers 11, an operating station 13 comprising a control device 22 for testing the imprint is present. A protective lacquer is subsequently sprayed onto the imprint or the container 11, respectively, in a further operating station 13 by means of a lacquering unit 23. Finally, the last operating station 13 is again embodied as transfer operating station 13a, which is equipped to deliver the finished container 11 from the apparatus 10, which, in turn, is identified by means of an arrow 0.

The order of the operating steps in the operating stations 13 is only exemplary. Many variations are possible hereby. For example, provision could also be made for operating stations 13 for mechanically processing the container 11, for example to cut off parts of the container 11, so as to shape the container 11 or to stamp it, etc. The number of the used active operating stations 13 can vary. In the case of the exemplary embodiment illustrated in FIG. 1, 13 operating stations are used actively. Depending on the concrete processing and on the type of the container 11, which is to be processed, more or fewer operating stations or operating steps, respectively, can also be necessary.

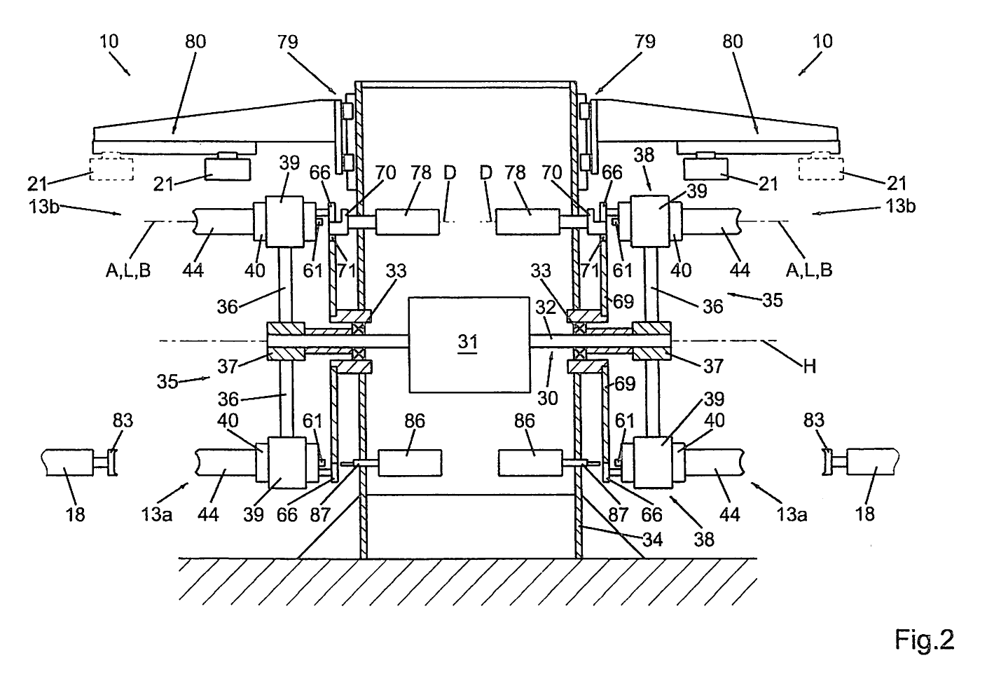

FIG. 2 shows an exemplary embodiment of an apparatus 10 in a schematic manner. The apparatus 10 encompasses a main drive 30 comprising a main drive motor 31, which drives a main shaft 32 intermittently in predetermined rotation angle intervals so as to rotate about a main axis H. The main drive motor 31 is embodied as electric motor. The main shaft 32 is supported in a machine frame 34 via a swivel arrangement 33 so as to be rotatable least at two locations. In the case of the exemplary embodiment, the main axis H runs approximately horizontally.

A support device 35, which is connected to the main shaft 32 in a torque-proof manner, is located at the main shaft. In the case of the exemplary embodiment described herein, the support device 35 encompasses a plurality of arms 36, which, starting at a bearing sleeve 37, which is connected to the main shaft 32 in a torque-proof manner, project diagonally away from the main axis H and preferably radially from the latter. The support device 35 supports a plurality of receiving units 38, which are arranged so as to be distributed evenly on the circular path 12 about the main axis H. A hollow-cylindrical accommodation 39 is fastened to the radially outer end of each arm 36 for this purpose. A cylindrical portion 40 of the receiving unit 38 is supported in the accommodation 39 so as to be rotatable via a further swivel arrangement 41. The cylindrical portion 40 encompasses a sleeve part 42, an axial end of which is closed by a cover 43.

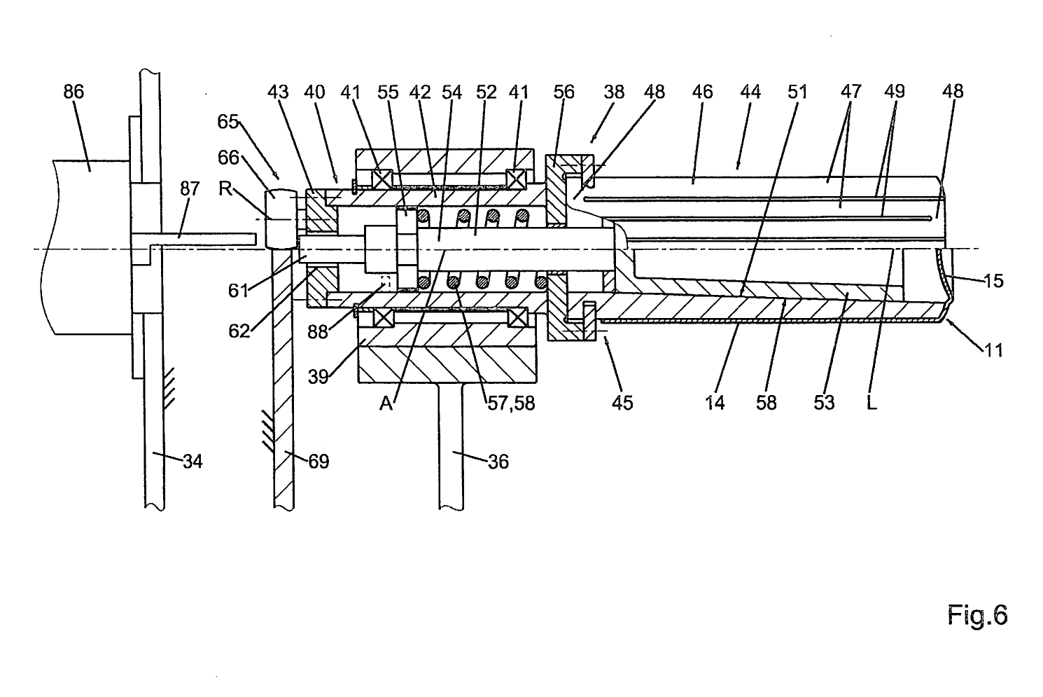

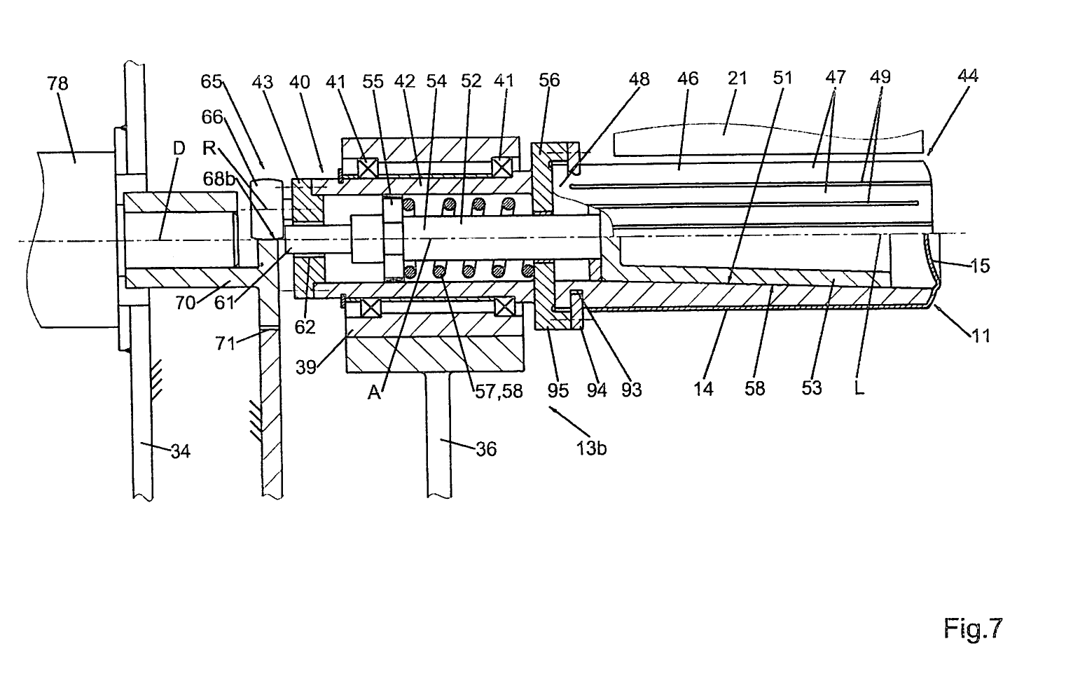

A clamping mandrel 44 of a holding device 45 of the receiving unit 38 is arranged on the axial end of the sleeve part 42 opposite the cover 43. The clamping mandrel 44 encompasses a cylindrical outer surface 46. It is formed from a plurality of clamping segments 47, which are connected to one another. The clamping segments 47 can be deformed elastically and are made of plastic, for example. In the case of the exemplary embodiment according to FIG. 6, two clamping segments 47, which are adjacent in circumferential direction of the clamping mandrel 44 about its longitudinal axis of the clamping mandrel S, are only connected to one another at an axial end area 48 and are otherwise separated from one another by means of a slit 49. According to the example, each clamping element is thereby connected to the two adjacent clamping elements 47 at axially opposite ends. The clamping mandrel 44 thus has a hollow-cylindrical shape, which is divided into the clamping segments 47 by slits 49, which are alternatingly introduced from opposite axial directions, wherein each slit 49 ends at an axial end area, which connects two adjacent clamping segments 47. Viewed in circumferential direction about its longitudinal axis L of the clamping mandrel, the clamping mandrel 44 thus has a meandering form around the slits 49.

At their inner side opposite the cylindrical outer surface 46, which faces the longitudinal axis L of the clamping mandrel, the clamping segments 47 in each case encompass a surface portion of a contact surface 51, which has the shape of truncated cone jacket surface. The space enclosed by the contact surface 51 tapers in a clamping direction S, which is oriented parallel to the longitudinal axis L of the clamping mandrel. The distance of the contact surface 51 is largest in the area of the free end of the clamping mandrel 44 and decreases from there in clamping direction S towards the end of the clamping mandrel 44, which is assigned to the cylindrical portion 40.

The holding device 45 encompasses a clamping ram 52. The clamping ram 52 can be moved along the longitudinal axis L of the clamping mandrel in clamping direction S and opposite the clamping direction S. The clamping ram 52 encompasses a clamping part 53, which is arranged in the interior of the clamping mandrel 44. The outer side of the clamping part 53, which faces the contact surface 51, forms a clamping surface 54, which coincides with the jacket surface of a truncated cone. The clamping part 53 tapers conically in clamping directions. The distance of the clamping surface 54 from the longitudinal axis L of the clamping mandrel thus decreases continuously in clamping direction S. In the case of the exemplary embodiment, the clamping part 53 is embodied as hollow body.

The clamping ram 52 furthermore encompasses an operating part, which, according to the example, is formed by an operating rod 54, which in particular encompasses a cylindrical shape. The operating rod 54 extends conically to the longitudinal axis L of the clamping mandrel. The operating rod 54 is fixedly connected to the clamping part 53 with an axial end. At its other axial end, the operating rod 54 encompasses a flange 55. The operating rod 54 permeates an opening in a wall 56, which is located between the cylindrical portion 40 of the receiving unit 38 and the clamping mandrel 44. At least one portion of the wall 56 extends diagonally to the longitudinal axis L of the clamping mandrel. The clamping mandrel 44 is fastened to the wall 56 via suitable fastening means.

To generate the clamping force or the holding force, respectively, between the holding device 45 and a container 11, which is held thereon, provision is furthermore made for a clamping means 57, which, in the case of a preferred exemplary embodiment, is formed by means of a helical spring 58. In the alternative, other spring-elastic means can also be used. The helical spring 58 is arranged within the sleeve part 42 and is supported on the wall 56 on the one side and on the flange 55 on the other side. The helical spring 58 is arranged around the operating rod 54. The clamping means 57, which is formed by the helical spring 58, thus exerts a force on the clamping ram 52 in clamping direction S. Via the clamping surface 58 and the contact surface 51, which rests against it, the diameter of the clamping mandrel 44 increases in response to a movement of the clamping ram 52 in clamping direction S. The slits 49 between the individual clamping segments 47 increase slightly viewed in circumferential direction about the longitudinal axis L of the clamping mandrel, whereby a widening of the clamping mandrel 44 is attained. If a container 11 is located on the clamping mandrel 44, the outer surface 46 of the clamping mandrel 44 is thus pressed against the inner surface of the container 11, so that the container 11 is held in a friction-locked manner on the clamping mandrel 44 of the holding device 45 of the receiving unit 38.

In axial extension of the operating rod 54, an operating part 61, which is guided out of the cylindrical portion 40 of the receiving unit 38 through an opening 62 in the cover 43, is fastened to the ram 52. The operating part 61 is arranged cylindrically and coaxially to the longitudinal axis L of the clamping mandrel, for example. In the case of the exemplary embodiment described herein, the operating part 61 is fixedly connected to the clamping ram 52. It connects to the flange 55.

As is illustrated in FIG. 6, for example, the cylindrical portion 40 and, according to the example, the sleeve part 42, projects out of the accommodation 39 at both axial ends. At the axial end opposite the clamping mandrel 44, a guide body arrangement 65 is fastened to the cylindrical portion 40 and, according to the example, to the cover 43. The guide body arrangement 65 encompasses at least one and, according to the example, two guide bodies, which, in the case of the exemplary embodiment, are formed by means of guide rollers 66. The guide rollers 66 are supported so as to be rotatable about a roller axis R, which runs parallel to the longitudinal axis L of the clamping mandrel in the case of the exemplary embodiment. A roller axis R is arranged on the attachment location at a distance to the longitudinal axis L of the clamping mandrel. The roller axis R is also arranged at a distance to the receiving axis A, which is defined by the further swivel arrangement 41 of the accommodation 39. The receiving axis A and the longitudinal axis L of the clamping mandrel coincide with one another. A rotation of the cylindrical portion 40 about the receiving axis A thus results in a rotation of the clamping mandrel 44 and therefore of the container 11, which is supported on the clamping mandrel 44, about the longitudinal axis L of the clamping mandrel.

Viewed in the direction of the path 12, which represents a circular path about the main axis H, along which the receiving units 38 move with the container 11, which are supported thereon, the two guide bodies or guide rollers 66, respectively, of the guide body arrangement 65 are arranged at a distance to one another. Viewed in the direction of the path 12, the receiving axis A is located between the two guide bodies or guide rollers 66, respectively.

The apparatus 10 encompasses a guide device 67 comprising a guide surface 68. The guide surface 68 runs parallel or along the path 12, along which the receiving units 38 move in response to a rotation of the main shaft 32. In the case of the preferred exemplary embodiment, the guide surface 68 is formed by first guide surface portions 68a and at least a second and, according to the example, a plurality of second guide surface portions 68b. The first guide surface portions 68a are arranged on a guide body 69. The guide body 69 is embodied in a ring-shaped or disk-shaped manner. The first guide surface portions 68a are provided at the circumferential side of the guide body 69.

One and, according to the example, a plurality of the operating stations 13, are embodied as rotary operating stations 13b. In the rotary operating stations 13b, the container 11 can be rotated via the receiving unit 38 about an axis of rotation D, which coincides with the longitudinal axis B of the container. The axis of rotation D is thereby defined by means of the coinciding axes A and L of the receiving unit 38.

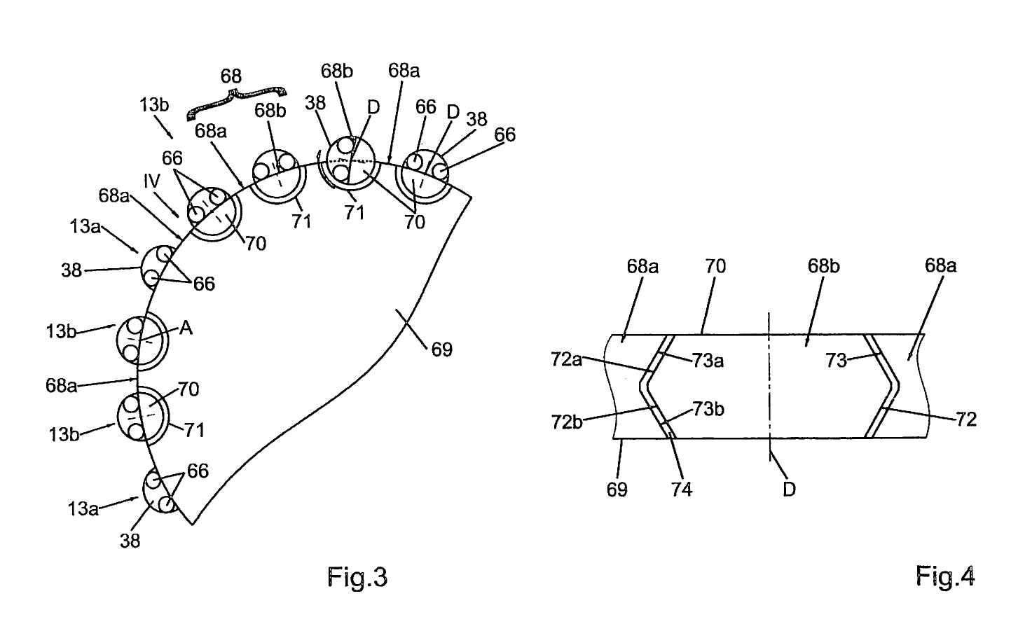

The receiving units 38 do not have their own drive. To attain a rotary motion in the rotary operating stations 13b, each rotary operating station 13b encompasses a guide segment 70, which is supported in an aperture 71 of the guide body 69 so as to be rotatable about the axis of rotation D (FIG. 3). A second guide surface portion 68b is in each case arranged on each guide segment 70. In an initial position of the guide segment 70, the second guide surface portion 68b thereof connects the two adjacent first guide surface portions 68a of the guide body 69 to one another, so that the first guide surface portions 68a and the second guide surface portions 68 together form a circular arc-shaped guide surface 68. The curvature of the second guide surface portions 68b coincides with the curvature of the first guide surface portions 68a at least in the end area of the first guide surface portions 68a, to which the second guide surface portion 68b adjoins, so that the curvature does not change at the transition point from a first to a second surface portion.

On its narrow or circumferential side, respectively, next to the second guide surface portion 68b, the guide segment 70 encompasses a segment surface 72, which runs in a circular arc-shaped manner, which, in the initial position of the guide segment 70, is arranged in the aperture 71 and which faces the guide body 69 in the case of the exemplary embodiment. There is no contact between the guide segment 70 and the guide body 69. In the initial position of the guide segment 70, a gap 74 is formed between the segment surface 72 and the aperture surface 73 of the guide body 79, which borders the aperture 71. The rotation of the guide segment 70 about the axis of rotation D relative to the guide body 69 is thus friction and wear-free.

The guide rollers 66 are pretensioned against the guide surface 68 by means of an adjustable force. If the main shaft 32 is rotated, the guide rollers 66 roll along the guide surface 68. To attain that the receiving units 38 are moved as free from vibration as possible in order to maintain the positioning accuracy of the transported containers 11, the gap 74 between the first surface portion 68a and the second surface portion 68b does not run at a right angle to the direction of motion of the guide rollers 66 along the guide path 68 and thus not parallel to the axis of rotation D according to the example.

In the case of the exemplary embodiment described herein, the aperture 71 is not bordered by a flat aperture surface 73, but the aperture surface 72 is designed so as to be concave and preferably encompasses two surface portions 73a and 73b, which draw an angle to one another and which thus form a grove-like depression in the aperture surface 73. Adapted accordingly, the segment surface 72 encompasses a convex shape and, according to the example, comprises two surface portions 72a and 72b, which are in each case located parallel opposite a surface portion 73a or 73b, respectively, of the aperture surface 73 and which thus also draw an angle relative to one another. Viewed in top view onto the second surface portion 68b (FIG. 4), the guide segment 70 tapers, starting at a central radial plane about the axis of rotation D in the direction of the axis of rotation D towards both sides. An angular or V-shaped gap 74 is thus formed between the guide segment 70 and the guide body 69.

As a variation to this, other gaps 74, which run diagonally to the movement of the guide rollers 66 along the guide surface 68, can also be realized.

If the guide roller 66 rolls along the guide surface 68 across a gap 74, it partially rests against the first surface portion 68a and partially against the second surface portion 68. A movement of the roller radially in the direction of the main axis H is thus avoided. A continuous transition, so to speak, is thus reached between the first guide surface portion 68a and the second guide surface portion 68b. In spite of the gap 74, a vibration-free movement of the guide rollers 66 along the guide surface 68 is possible in this manner. The width of the guide rollers 66 coincides at least with the width of the guide surface 68.

Each rotary operating station 13b encompasses a rotary drive 68. The rotary drive 78 is preferably formed by an electromotor. The rotary drive 78 is supported on the machine frame 34 and supports the guide element 70. Based on the plane, which is defined by the guide body 69, the rotary drive 68 is arranged on the side of this plane opposite the receiving units 38.

The guide body 69 is fixedly arranged on the machine frame 34. In the case of the exemplary embodiment, the disk-shaped guide body 69 extends in a vertical plane.

The rotary operating stations 13b are identified in FIG. 1 by means of an arrow about the axis of rotation D. For example, the operating stations 13, in the case of which the container 11 is imprinted, are embodied as rotary operating stations 13b. In particular, all of the operating stations 13 can be embodied as rotary operating stations 13, except for the transfer operating stations 13a, in which a container 11 is taken over (arrow I) or is delivered (arrow 0) by the apparatus 10.

In the schematic sectional view according to FIG. 2, a rotary operating station 13b comprising a printer unit 21 as well as a transfer operating station 13a comprising a transfer unit 18 are illustrated in an exemplary manner. The transfer unit 18 serves to supply as well as to remove containers 11 into or out of the apparatus 10, respectively.

As is illustrated in FIG. 2, the printer unit 21 can be moved diagonally to the clamping mandrel 44 via a first carriage guide 79 so as to adapt the distance at the container 11. A second carriage guide 80 serves the purpose of moving the printer unit 21 between a printing position next to the clamping mandrel 44 and a cleaning position, which is spaced apart from the clamping mandrel 44. According to the example, the movement between printing position and cleaning position is carried out approximately parallel to the longitudinal axis L of the clamping mandrel or to the receiving axis A, respectively, of the receiving unit 38. This also coincides with the orientation of the main axis H. The cleaning position of the printer unit 21 is illustrated in a dashed manner in FIG. 2.

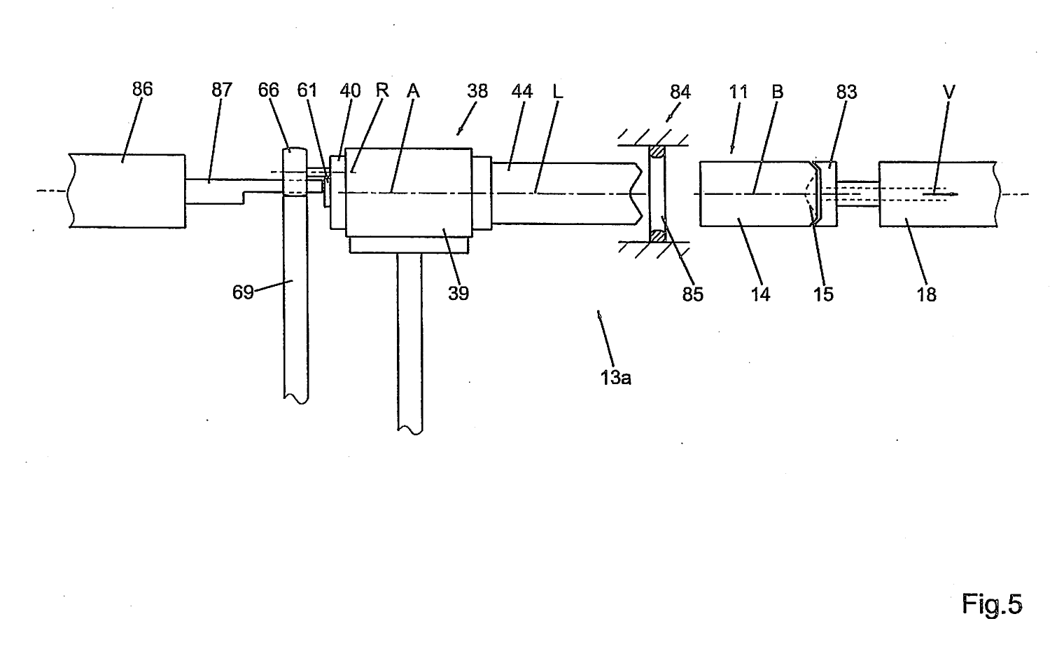

The transfer operating station 13b for supplying a container 11 to the apparatus 10 is illustrated schematically in FIG. 5. The transfer unit 18 encompasses a holding plate 83, which seizes the container 11 in the area of the container base 15. For this purpose, the transfer unit 18 can generate a low pressure between the container base 15 and the holding plate 83, as is illustrated schematically by means of the arrow V in FIG. 5. The container 11 is thus held on the holding plate 63 in a friction-locked manner.

The transfer unit 18 moves the container 11 with its open side first towards the clamping mandrel 44 via a non-illustrated drive. The longitudinal axis L of the clamping mandrel and the longitudinal axis B of the container are thereby aligned with one another. Due to the fact that the container 11 is very thin-walled and encompasses a low inherent rigidity, a pre-centering device 84 is arranged concentrically around the longitudinal axis L of the clamping mandrel. Concentrically to the longitudinal axis L of the clamping mandrel, the pre-centering device can encompass centering ring 85 or a plurality of centering bodies distributed in circumferential direction, so that the container 11 can be attached with its open side to the clamping mandrel 44 in an accurate as well as in a problem-free manner.

To provide for the attachment of the container 11 to the clamping mandrel 44, the latter is brought into its release position. For this purpose, the transfer operating station 13a encompasses an actuator 86. The actuator 86 is supported on the machine frame 34 in a stationary manner. In the case of the exemplary embodiment, it is designed as linear motor, for example as electric spindle motor. The actuator 86 encompasses an actuator element 87, which can be shifted linearly along the receiving axis A. To switch the holding device 45 or the clamping mandrel 44, respectively, into the release state, the actuator element 87 is moved against the operating part 61 of the assigned receiving unit 38 and is shifted opposite the clamping direction S. The operating ram 52 thereby also shifts opposite the clamping direction S, whereby the clamping segments 47 are not pushed away from the longitudinal axis L of the clamping mandrel and assume a radially inner position due to their elasticity. The diameter of the clamping mandrel 44 is thereby reduced and is smaller in the release state than the inner diameter of the container 11, so that the latter can be pushed onto the clamping mandrel 44. Once the container 11 has been pushed onto the clamping mandrel 44, the actuator 86 can move the actuator element 87 in clamping direction S, so that the operating part 61 is moved together with the clamping ram 52 in clamping direction S by means of the force of the clamping means 57. The clamping segments 47 are pushed away from the longitudinal axis L of the clamping mandrel to the outside via the clamping part 53 and thereby push against the jacket surface 14 of the container 11 form the inside, so as to secure said container to the holding device 45. A stop element 88, which limits the movement of the clamping ram 52 in clamping direction S, can be assigned to the clamping ram 52.

As is illustrated schematically in FIG. 5, the actuator element 87 engages between the two guide rollers 66 and past the guide body 69 in response to the operation of the operating part 61.

The principle of the transfer operating station 13a, in the case of which a container 11 is removed (arrow 0 in FIG. 1) is essentially identical, wherein the pre-centering device 84 can be foregone. The operational procedure in response to removing a container 11 from a receiving unit 38 takes place vice versa. The operating part 61 is initially operated by the actuator 86, so as to switch the holding device into the release position. The transfer unit 18 can subsequently seize the container 11 at the container base 15 by means of the holding plate 83 and can remove it from the clamping mandrel 44.

The container 11 is processed, tested, controlled or is imprinted, as in the case of the exemplary embodiment, in the rotary operating stations 13b. The container 11 is thereby rotated about its longitudinal axis of the container L. To attain this, the rotary drive 78 effects a rotation of the guide segment 70 about the axis of rotation D. The guide body arrangement 65, which rests against the guide segment 70, thus also moves about the axis of rotation D and initiates a rotation of the cylindrical portion 40 in the accommodation 39 about the receiving axis A. Due to the fact that the longitudinal axis of the container L coincides with the receiving axis A, this leads to a rotation of the container 11 about its longitudinal axis of the container L. During this rotation, a motif can be imprinted across the entire jacket surface 14, e.g., the imprinted motif or the container 11 can be controlled or a mechanical processing—in particular by means of laser cutting—of the container 11 can take place.

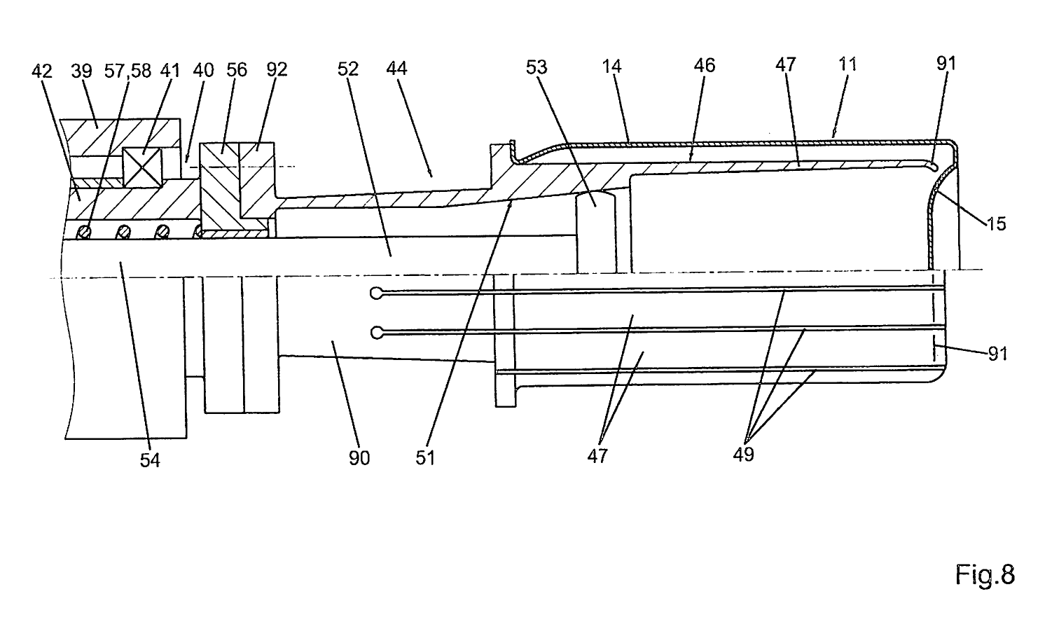

FIG. 8 shows a modified embodiment of the holding device 45. In contrast to the above-described exemplary embodiment, all of the slits 49 are thereby open towards the free end of the clamping mandrel 44. The adjacent clamping segments 47 are connected to one another at the axial end area 48, which is assigned to the cylindrical portion 40. In the area of the wall 56, the clamping mandrel 44 thus encompasses a ring portion 90, which is free from slits 49.

In the case of this alternative embodiment, the clamping part 53 is embodied as disk or ring and rests against the contact surface 51 of the clamping mandrel 44 or of the clamping segments 47, respectively. If the clamping part 53 is moved in clamping direction S, it presses the clamping segments 47 radially outwards via the contact surface 51. The clamping mandrel thus initially widens most at its free end, until the elastically deformable clamping segments 47 rest against the interior of the jacket surface 14 of the container 11. If the clamping ram 52 and thus the clamping part 53 are moved further in clamping direction S, the clamping segments 47 rest gradually against the inside of the jacket surface 14 across an ever increasing portion, starting at their free end 91. As illustrated in FIG. 8, this embodiment is in particular suitable for containers 11, which taper towards their opening. For example, these can be so-called “necked” containers 11. The holding device 45 according to FIG. 8 can be used in the case of the above-described exemplary embodiments of the apparatus 10. The exact embodiment of the holding device 45 or of the clamping mandrel 44, respectively, depends on the design and the form of the containers 11, which are to be received.

In the case of both of the exemplary embodiments of the holding device 45, the clamping mandrel 44 is fastened to the wall 56 of the receiving unit 38 via suitable fastening means. In the case of the exemplary embodiment according to FIG. 8, the clamping mandrel 44 encompasses a fastening flange 92 for this purpose, by means of which it is screwed directly to the wall 56. In the alternative, one or a plurality of holding apertures 93, respectively, can be introduced into the clamping mandrel from outside in the case of both of the exemplary embodiments. A preferably multi-part ring 94 can be inserted into this at least one holding aperture 93 coaxially about the longitudinal axis L of the clamping mandrel. The clamping mandrel 44 can be screwed to the wall 56 with the help of this ring 94. For example, the wall 56 can encompass a ring-shaped axial projection 95 or a plurality of axial projections 95 for this purpose, to which the ring 94 can be attached and screwed.

The different fastening possibilities of the clamping mandrel 44 can be realized in the case of all of the exemplary embodiments of the holding device 45.

As illustrated in FIG. 2, a processing system for containers 11 is illustrated therein, in the case of which two apparatuses 10 according to the invention are present. The latter are arranged together on the machine frame 34 of the processing system. The main drive 30 comprising the main drive motor 31 and the main shaft 32 is thereby assigned to both of the apparatuses 10. The processing system is thereby embodied symmetrically to a vertical center plane. It is also possible to embody the operating stations 13 of both apparatuses 10 in different ways.

The invention relates to a transporting apparatus 10 for transporting and/or positioning containers 11 in a stepwise manner between successive operating stations 13. Each container 11 is thereby received by a receiving unit 38 and is moved about a main axis H together with the receiving unit 38 along a circular path 12. The operating stations 13 are spaced apart at predetermined angular intervals along the circular path 12. Each receiving unit 38 encompasses a guide body arrangement 65, which, when the receiving unit 38 moves along the circular path 12, is supported on a guide surface 68. The guide surface 68 encompasses first guide surface portions 68a and second guide surface portions 68b. The first guide surface portions 68a are arranged on a guide body 69. The second guide surface portions 68 are arranged on guide segments 70. The guide segments 70 are located in apertures 71 of the guide body 69 at operating stations configured as rotary operating stations 13b. The guide segments 70 can be rotated about an axis of rotation D. When the guide segment 70 is rotated about the axis of rotation D, the guide body arrangement 69 also moves about this axis of rotation D and, at the same time, the receiving unit 38 as a whole likewise rotates about the axis of rotation D, which coincides with the longitudinal axis B of the containers.

### LIST OF REFERENCE NUMERALS

10 apparatus
11 container
12 path
13 operating stations
13a transfer operating station
13b rotary operating station
14 jacket surface
15 container base
18 transfer unit
19 recording unit
20 testing unit
21 printer unit
22 control unit
23 lacquering unit
30 main drive
31 main drive motor
32 main shaft
33 swivel arrangement
34 machine frame
36 arm
37 bearing sleeve
38 receiving unit
39 accommodation
40 cylindrical portion
41 swivel arrangement
42 sleeve part
43 cover
44 clamping mandrel
45 holding device
46 outer surface
47 clamping segment
48 axial end area
51 contact surface
52 clamping ram
53 clamping part
54 operating rod
55 flange
56 wall
57 clamping means
58 clamping surface
61 operating part
62 central opening
65 guide body arrangement
66 guide roller
67 guide device
68 guide surface
68a first guide surface portion
68b second guide surface portion
69 guide body
70 guide segment
71 aperture
72 segment surface
72a surface portion of the segment surface
72b surface portion of the segment surface
73 aperture surface
73a surface portion of the aperture surface
73b surface portion of the aperture surface
74 gap
78 rotary drive
79 first carriage guide
80 second carriage guide
83 holding plate
84 pre-centering device
85 centering ring
86 actuator
87 actuator element
88 stop element
90 ring portion
91 free end of the clamping segments
92 fastening flange
93 fastening aperture
94 ring
95 axial projection
A receiving axis
B longitudinal axis of the container
D axis of rotation
H main axis
L longitudinal axis of the clamping mandrel
S clamping direction
I arrow
0 arrow
R roller axis
T arrow
V arrow

I claim:

1. An apparatus (10) for transporting and/or positioning cylindrical containers (11) between different operating stations (13),
comprising a main drive (30), which is equipped to move receiving units (38) for the containers (11) along a predetermined path (12) from an operating station (13) to an adjacent operating station (13),
wherein each receiving unit (38) encompasses a holding device (45) for holding a container (11) and a guide body arrangement (65),
comprising a guide device (67), which encompasses a guide surface (68), which extends along or parallel to the path (12), on which the guide body arrangements (65) of the receiving units (38) are supported,
wherein the guide device (67) encompasses a guide segment (70), which can be driven about an axis of rotation (D) and on which a surface portion (68b) of the guide surface (68) is arranged, at least at one of the operating stations (13), which is embodied as rotary operating station (13b).

2. The apparatus (10) according to claim 1, characterized in that the guide surface (68) encompasses a ring-shaped and in particular a circular ring-shaped form.

3. The apparatus (10) according to claim 2, characterized in that the guide device (67) encompasses a disk or ring-shaped guide body (69), on which a plurality of first surface portions (68a) of the guide surface (68) are arranged.

4. The apparatus (10) according to claim 3, characterized in that, at the at least one rotary operating station (13b), the guide body (69) encompasses an aperture (71), in which the guide segment (70) is arranged.

5. The apparatus (10) according to claim 4, characterized in that the curvature of the second surface portion (68b) coincides with the curvature of the two adjacent first surface portions (68a) of the guide surface (68).

6. The apparatus (10) according to claim 1, characterized in that each rotary operating station (13b) encompasses a rotary drive (78) for rotating the guide segment (70).

7. The apparatus (10) according to claim 1, characterized in that the main drive (30) encompasses a main shaft (32), which is driven about a main axis (H), in particular intermittently.

8. The apparatus (10) according to claim 7, characterized in that a support device (35) is connected to the main shaft (32) in a torque-proof manner, wherein the support device (32) encompasses a plurality of accommodations (39), in which a receiving unit (38) is in each case arranged so as to be rotatable about a receiving axis (A) relative to the support device (35).

9. The apparatus (10) according to claim 8, characterized in that the guide body arrangement (65) encompasses one or a plurality of guide bodies (66), which are arranged so as to be offset relative to the receiving axis (A).

10. The apparatus (10) according to claim 1, characterized in that the holding device (45) encompasses a cylindrical clamping mandrel (44) comprising a plurality of clamping segments (47), which are pressed radially away from the longitudinal axis of the clamping mandrel (L) by means of the force of a clamping means (57) in outward direction.

11. The apparatus (10) according to claim 10, characterized in that the clamping means (57) acts on a clamping ram (52), which can be moved in the direction of the longitudinal axis of the clamping mandrel (L), in a clamping direction (S).

12. The apparatus (10) according to claim 11, characterized in that the clamping ram (52) encompasses a clamping part (53) comprising a clamping surface (58), which tapers conically in clamping direction (5).

13. The apparatus (10) according to claim 12, characterized in that the clamping segments (47) form a contact surface (51), which is adapted to the conical form of the clamping surface (58) and which rests against the clamping surface (58).

14. The apparatus (10) according to claim 13, characterized in that the holding device (45) encompasses an operating part (61), which can be moved against the force of the clamping means (57) for releasing the clamping force between the clamping mandrel (44) and a container (11), which is held on the clamping mandrel (44).

15. The apparatus (10) according to claim 14, characterized in that at least one of the operating stations (13) is embodied as transfer operating station (13a), which encompasses an actuator (86) for operating the operating part (61).
